(19) United States
(12) Patent Application Publication
(10) Pub. No.: US 2003/0026889 A1
(43) Pub. Date: Feb. 6, 2003

(54) Soybean food product

(76) Inventors: Michael Vilkin, San Diego, CA (US); Tamara Vilkin, San Diego, CA (US)

Correspondence Address: MICHAEL VILKIN, 309 N. SOLANA HILLS DRIVE, APT. 48, SOLANA BEACH, CA, 92075, US

(21) Appl. No.: 09/909,093

(22) Filed: Jul. 20, 2001

(51) Int. Cl. A23L 1/20

(52) U.S. Cl. 426/634

(57) ABSTRACT

Formulation of our soybean food product includes cooked soybeans, crushed peanuts, whole spices, dry spices, garlic, grapeseed oil, lemon juice, salt and water. All ingredients are combined in a food processor and pureed until smooth.

### BACKGROUND OF THE INVENTION

Our invention is a new soybean food product.

It's common knowledge that soybeans have very high nutritional value. US Food and Drug Administration recommends to eat soybeans every day.

This new soybean product has delicious taste and flavor. When manufactured commercially, this product will provide very high nutritional benefits to millions of consumers.

### BRIEF SUMMARY OF THE INVENTION

Our method of preparing new soybean food product is described in steps. There are 7 steps.

1. Soak soybeans in water for 10-12 hrs.

2. Drain water from soybeans.

3. Put soybeans in water and boil for 30 minutes. Quantity of water should be just enough to cover the soybeans.

4. Soak soybeans in hot water for 30 more minutes.

5. Make peanut butter out of roasted peanuts.

6. Combine soybeans, peanut butter, minced fresh cilantro, minced fresh parsley, minced fresh dill, crushed fresh garlic, dry spices, salt, lemon juice, grapeseed oil in a food processor.

Add also water the soybeans were cooked in.

7. Puree until smooth.

### DETAILED DESCRIPTION OF THE INVENTION

Our method of preparing new soybean food product is described in steps. There are 7 steps.

1. Soak soybeans in water for 10-12 hrs.

2. Drain water from soybeans.

3. Put soybeans in water and boil for 30 minutes. Quantity of water must be just enough to cover the soybeans.

4. Soak the soybeans in the hot water for 30 more minutes.

5 Make peanut butter out of roasted peanuts.

6. Combine soybeans, peanut butter, minced fresh cilantro, minced fresh parsley, minced fresh dill, crushed fresh garlic, dry spices, salt, lemon juice, grapeseed oil in a food processor.

Add also water the soybeans were cooked in.

7. Puree until smooth.

### FORMULATION OF OUR SOYBEAN FOOD PRODUCT

Quantity of ingredients is given in both weight and percentage. It should be noted that 1 lb of dry soybeans will become approximately 3 lbs of cooked soybeans. Weight and percentage of all ingredients are based on 3 lbs of cooked soybeans.

### Weight and Percentage of the Ingredients

| | | | |
|---|---|---|---|
| 1. Cooked soybeans | 3 | lbs | 60% |
| 2. Water soybeans were cooked in | 1 | lb | 20% |
| 3. Peanut butter | 0.4 | lb | 8% |
| 4. Crushed fresh garlic | 0.2 | lb | 4% |
| 5. Lemon juice | 0.1 | lb | 2% |
| 6. Minced fresh cilantro | 0.05 | lb | 1% |
| 7. Minced fresh parsley | 0.05 | lb | 1% |
| 8. Minced fresh dill | 0.05 | lb | 1% |
| 9. Grapeseed oil | 0.05 | lb | 1% |
| 10. Dry spices | 0.05 | lb | 1% |
| 11. Salt | 0.05 | lb | 1% |

It should be noted that dry spices are given as 1 ingredient. Dry spices consist of equal parts of 7 spices:

1. Basil

2. Chilli pepper

3. Cayenne pepper

4. Ground coriander

5. Ground cumin

6. Oregano

7. Rosemary

This line is the end of the detailed description.

1. What we claim as our invention is a unique formulation of a delicious soybean food product.
FORMULATION OF OUR SOYBEAN FOOD PRODUCT
Quantity of ingredients is given in both weight and percentage. It should be noted that 1 lb of dry soybeans will become approximately 3 lbs of cooked soybeans. Weight and percentage of all ingredients are based on 3 lbs of cooked soybeans:
Weight and percentage of ingredients.

| | | | |
|---|---|---|---|
| 1. Cooked soybeans | 3 | lbs | 60% |
| 2. Water soybeans were cooked in | 1 | lb | 20% |
| 3. Peanut butter | 0.4 | lb | 8% |
| 4. Crushed fresh garlic | 0.2 | lb | 4% |
| 5. Lemon juice | 0.1 | lb | 2% |
| 6. Minced fresh cilantro | 0.05 | lb | 1% |
| 7. Minced fresh parsley | 0.05 | lb | 1% |
| 8. Minced fresh dill | 0.05 | lb | 1% |
| 9. Grapeseed oil | 0.05 | lb | 1% |
| 10. Dry spices | 0.05 | lb | 1% |
| 11. Salt | 0.05 | lb | 1% |

It should be noted that dry spices are given as 1 ingredient. Dry spices consist of equal parts of 7 spices:
1. Basil
2. Chilli pepper
3. Cayenne pepper
4. Ground coriander
5. Ground cumin
6. Oregano
7. Rosemary
When a correct techological process is applied, this soybean food product has delicious taste and flavor as well as very high nutritional value.
